(19) United States
(12) Patent Application Publication
(10) Pub. No.: US 2003/0079459 A1
(43) Pub. Date: May 1, 2003

(54) Picking roll

(76) Inventors: Dirk Bongert, Stadtlohn (DE); Alfons Resing, Stadtlohn (DE)

Correspondence Address: Deere & Company, One John Deere Place, Moline, IL, 61265-8098, US

(21) Appl. No.: 10/263,595

(22) Filed: Oct. 2, 2002

(30) Foreign Application Priority Data
Oct. 26, 2001 (DE) 101 52 982.1

(51) Int. Cl. A01D 45/02

(52) U.S. Cl. 56/104

(57) ABSTRACT

A picking roll for engaging a standing agricultural plant, has a picking section for tangentially pulling in the standing plant. The picking section is divided into a first picking portion and a second picking portion. The first picking portion is driven at a first rotational speed and the second picking portion is driven at a second rotational speed that is different from the first rotational speed.

### FIELD OF THE INVENTION

The present invention is directed to a picking roll for a harvesting machine.

### BACKGROUND OF THE INVENTION

Pickers are used in agricultural harvesting machines to separate the multiple fruits of plants from the other parts of the plants. Such pickers generally have two picking rolls, between which the plant stem is pulled in. Occasionally only one picking roll is used, which cooperates with a fixed wall. The picking roll or rolls pull the plant through a picking gap whose dimensions are narrower than the fruit. In this way the fruit, for example, a corn cob, is separated from the remainder of the plant and can be processed separately. The picking rolls are often provided with outwardly protruding carriers that extend over their length, which are mounted on a tubular base.

In addition the picking rolls maybe provided with helical flights with threaded tips can be arranged to pull in the plant axially, as disclosed in U.S. Pat. No. 4,377,062 A, conical picking rolls are disclosed in U.S. Pat. No. 2,870,593 A, U.S. Pat. No. 3,832,836 A, DE 1 757 213 A, DE 2 313 519 A, DE 197 30 912 A and EP 0 943 229 A. The helical flights of the picking rolls have a smaller diameter at the front than at the rear region. Because of this, a situation is achieved in which the plants in their lower region, cooperating with the front sections of the picking roll having a smaller diameter, are pulled in relatively slowly. The upper, thinner parts of the plant are pulled in at higher speed by the rear region of the picking rolls having a larger diameter. In this way the cob attached to the lower part of the plant is pulled in relatively slowly during stripping in the picking gap and therefore treated gently, whereas the upper thin part of the stem is pulled in rapidly.

The two last-named refercnes disclose that the axes of the cooperating picking rolls converge so that the gap remaining between the picking rolls is of constant width over its length. A picker with conical picking rolls is also shown in U.S. Pat. No. 1,641,436 A, whose axes converge so that the width of the gap between the picking rolls is constant over its length. However, the picking rolls are thicker on the lower end than on the upper end.

A picker with a picking roll constructed from two sections is described in U.S. Pat. No. 2,656,666 A. A front gathering section of the picking roll in the forward direction of travel has a larger diameter than the rear picking section. The rotational axes of the front and rear sections are offset laterally relative to each other so that the width of the gap between adjacent cooperating picking rolls is constant over its length. The picking section of the picking roll placed in rotation via a gear mechanism drives the gathering section via a coaxial gear on the front, which cooperates with internal gearing of the gathering section. Because of this the gathering and picking section rotate in opposite directions, the speed of the picking section being higher than that of the gathering section.

It is considered a shortcoming in pickers with conical picking rolls that in picking rolls with their axes arranged parallel the spacing between the cooperating picking rolls is reduced successively rearward, which can lead to crushing of the plant stems in the rear region, which increases the drive power to be applied, whereas in picking rolls with converging axes demanding and costly angular gears are required. The cylindrical picking rolls do not pull in the plant at an accelerating rate over the length of the picking rollsr.

### SUMMARY OF THE INVENTION

It is an object of the present invention to provide an improved picking roll for an agricultural harvesting machine.

The present invention comprises a picking roll having a picking section that is rotatively driven to pull in a plant through a picking gap. The plant is pulled in by the picking roll with a tangential movement component, in which axial movement can also be present. The picking section of the picking roll has first and second portions that can be rotatively driven at different speeds.

By appropriate layout of the drives for the portions, a situation can be achieved in which a plant is initially pulled in with relatively low speed, but later with higher speed. The slower rotating front portion then preferably cooperates with the parts of the plant carrying multiple fruits.

The pulling-in behavior can be achieved with cylindrical picking rolls that can be manufactured less expensively than the conical picking rolls so that no successively narrowing gap is required between the cooperating picking rolls and no angular gears are required. However, it would also be conceivable to use conical picking rolls whose axes are arranged parallel or converging.

In order to achieve constant spacing between cooperating picking rolls over the length of the picking gap, the diameter of the enveloping circle of the first and second portion are approximately the same.

In a first embodiment, the first portion can initially be driven in known fashion from the back side of the picking roll, whereas the second portion is driven by a shaft arranged in the interior of the first portion. If three (or more) portions are rotatively driven with different speeds or a feed auger is mounted in front of the picking region to pull the plant into the picking region, the third portion or the feed auger is driven by a shaft that extends through a hollow shaft that drives the second portion. The shafts end on the back side of the picking roll and are driven by gears or other drives with the desired speed. It should be noted that the direction comments, like front and back, refer to the path of the plant over the length of the picking gap in the axial direction of the picking roll.

In another embodiment, the second portion and/or the third portion are driven via planet gears. An axially arranged shaft extends from the back side of the picking roll up to the second or third portion. A sun gear meshes with the planet gears and is arranged on the shaft. The latter again mesh with internal gearing of the second and third portions of the picking roll. The planet gears are mounted on fixed carriers. By appropriate dimensioning of the gears, which is different for the corresponding portions, the desired different speeds are achieved. The first portion is driven either directly or by a planet gear driven by the shaft.

Finally, the second and/or the third portion of the picking section (or the feed auger) can be equipped with external gearing that cooperates with a drive pinion arranged outside the picking roll. A drive via a toothed or smooth belt would also be conceivable. The region of the external gearing facing the plants could be provided with a fixed cover in order to prevent trapping of plant residues in the external gearing.

### BRIEF DESCRIPTION OF THE DRAWINGS

FIG. 1 is a top view of a picking device of a harvesting machine with picking rolls according to a first embodiment.

FIG. 2 is a side view of the picking device from FIG. 1.

FIG. 3 is a vertical cross section view of the picking device from FIG. 1.

FIG. 4 is a side view of the picking device from FIG. 1.

FIG. 5 is a top view of a harvesting machine with a second embodiment of the picking rolls.

FIG. 6 shows a perspective view of a third embodiment of a picking roll.

### DETAILED DESCRIPTION

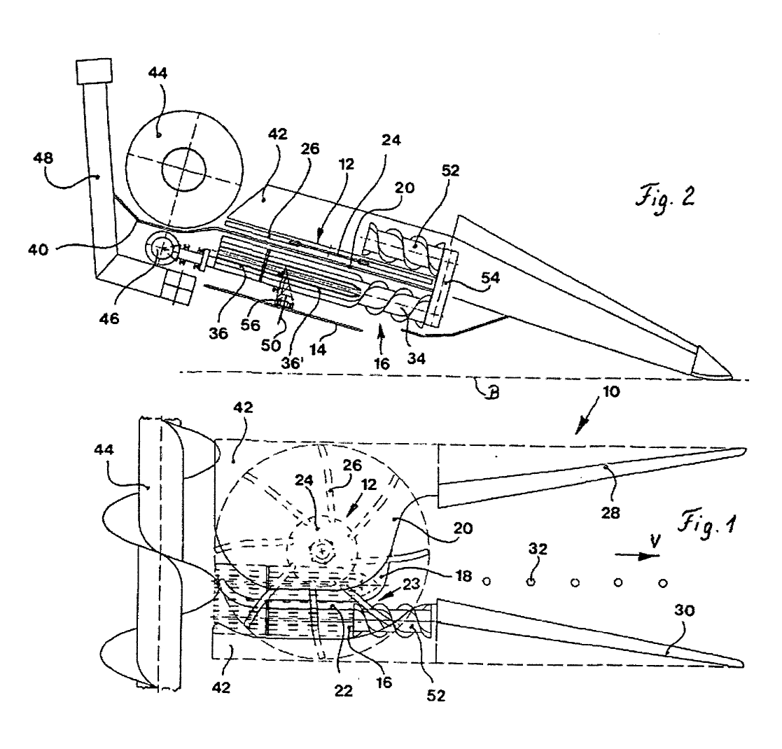

A picking device 10 of a harvesting machine is shown in FIG. 1. The picking device 10 comprises a gathering element 12, a rotatable chopping blade 14, a first picking roll 16, a second picking roll 18, and a picking gap 22 formed in a stripping plate 20. The gathering element 12 is used to grasp and pull the plant being harvested into the picking rolls 16 and 18. Both picking rolls are arranged beneath the picking gap 22.

The upper gathering element 12 is arranged to rotate around a predominantly vertical axis and is rotated in a clockwise direction in FIG. 1. The gathering element 12 is arranged above the stripping plate 20 and has a rotational axis sloped slightly forward. The gathering element 12 in its basic design comprises a central disk 24 with radially extending fingers 26 distributed around its periphery. The fingers 26 are curved in the plane of the disk 24 opposite the direction of rotation, i.e., a trailing direction. The crop dividers 28 and 30 are arranged in front of gathering elements 14 and 16 in the forward direction of movement V of the harvesting machine. The edge of the stripping plate 20 also running in the forward direction of movement is curved so that the stems of the plants 32 are forced into the region of the gathering element 12.

The method by which a plant is gathered by the gathering element 12 is readily apparent with reference to FIG. 1. A stem of a standing plant 32 comes into contact with a finger 26 of the gathering element 12 after it has been bent, if required, by one of the crop dividers 28 or 30 and/or the leading edge of the stripping plate 20. The stem is guided by the leading surface of finger 26 and forced outward owing to the trailing curvature of finger 26. In this manner, the stem of plant 32 is transported by finger 26 into picking gap 22, which extends at least roughly parallel to the forward direction of movement V, and is inserted between the first picking roll 16 and the gathering element 12 into the stripping plate 20.

The first picking roll 16 is arranged laterally next to the gathering element 12 and sloped slightly forward and downward. Viewed in the lateral direction, it is oriented parallel to the forward direction of movement V. In the front region of the first picking roll 16 lying upstream with reference to the direction of movement of the plant 32, a feed auger 34 is located, which pulls in the stem of plant 32 into picking gap 22 in cooperation with the gathering element 12. The end 23 of picking gap 22 on the inlet side lies in front of the rotational axis of gathering element 12 at the site at which the distance between the two portions of the stripping plate 20, initially tapering in the direction of movement of the plant 32, has assumed its constant value over the length of the picking gap 22.

A feed element in the form a feed auger 52 is located above the gathering element 12 and the inlet end 23 of picking gap 22. The feed direction of the feed element 52 extends parallel to the first picking roll 16. The feed element 52 has about one-third the length of the first picking roll 16 and is placed in rotation by means of a gear mechanism 54 that makes a drive connection with the front side of the first picking roll 16. The housing of gear mechanism 54 is mounted on the stripping plate 20.

The stem of a plant 32 grasped by a finger 26 of the gathering element 12 is forced by finger 26 against the feed element 52. The feed rate of the feed element 52 is adjusted to the feed rate of feed auger 34 and gathering element 12 so that the plant 32 is moved by the feed auger and gathering element 12 synchronously rearward into the picking gap 22. The feed element 52 provides support and conveyance to the plant 32 above the finger 26 of the gathering element 12. By cooperation of the two feed augers and the finger 26, the plant 32 is reliably held and guided linearly into the picking gap 22 and between picking rolls 16 and 18.

The stem of plant 32 enters the active picking region of the second picking roll 18, whose front tip (viewed with reference to the forward direction of movement V) also lies in front of the rotational axis of the gathering element 12. The second picking roll 18 is oriented parallel to the first picking roll 16 and arranged between the latter and the rotational axis of the gathering element 12. A gap is defined between the first picking roll 16 and the second picking roll 18 vertically beneath the picking gap 22. The picking region of the first and second picking rolls 16 and 18 are cylindrical over their entire length and provided in known fashion with axially running outward protruding carriers 38, as are best apparent in FIG. 3. The picking regions of the two picking rolls 16 and 18 are of equal length. The axes of the picking roll 16 and 18 run parallel to each other. With reference to FIG. 3, the first picking roll 16 rotates clockwise and the second picking roll 18 counterclockwise. The second picking roll 18 and the picking region of the first picking roll 16 pull the stem of the plant 32 downward. The stripping plate 20 on both sides of picking gap 22 serves to strip off the useful parts of plant 32.

The useful parts of plants 32 separated by the picking device, like corn cobs, multiple fruits of sunflowers, etc. are conveyed by the gathering element 12 into a trough 40 arranged behind the gathering and picking device 10. Covers 42 on both sides of the picking gap 22 define a channel leading to trough 40 through which the useful parts of the plants 32 are conveyed. A transverse feed auger 44 is arranged above trough 40 and transports the useful parts to a harvesting vehicle (for example, a combine harvester or self-propelled field chopper) or onto a trailer. A shaft 46, which serves to drive the two picking rolls 16 and 18, the chopping blade 14, the feed element 52 and the gathering element 12 of the gathering and picking devices 10 is arranged beneath the trough 40. The shaft 46 is drivingly connected with the engine of a vehicle carrying the harvesting machine. A frame 48 carries the gathering and picking devices 10 of the harvesting machine, all of which are driven by shaft 46.

The rest of plant 32 that is transported downward from the picking rolls 16, 18 reaches the region of action of the rotating, four-armed chopping blade 14 and is chopped into individual pieces. The chopping blade 14 rotates around a vertically running rotational axis 50 that is arranged between the rotational axis of gathering element 12 and transverse feed auger 44 and is driven by the shaft 46 via an angular gear 56.

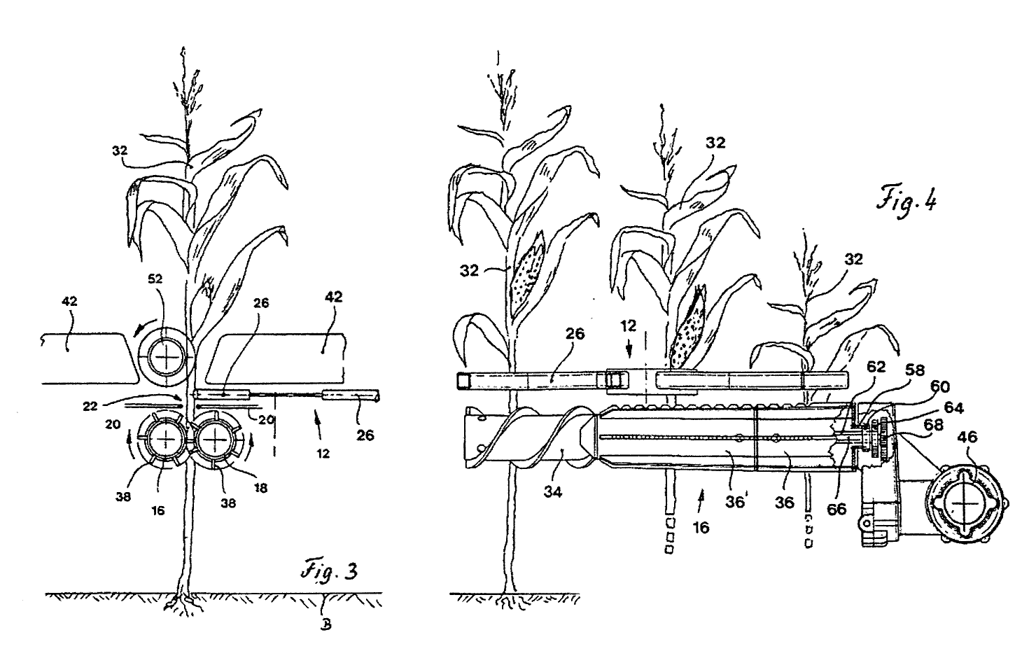

As shown in FIG. 4, the picking region of the first picking roll 16 is subdivided into a first portion 36 and a second portion 36′, which are arranged axially one behind the other. The length of the second portion 36′ is roughly twice that of the first portion 36. The first portion 36 is connected to a first gear 60 by a first relatively short hollow shaft 58. The second portion 36′ is connected to a second gear 64 by a second hollow shaft 62 that extends through the first hollow shaft 58. The screw auger 34 on the front side of the first picking roll 16 is connected by a shaft 66 that extends through the second hollow shaft 62 to a third gear 68. The gears 60, 64 and 68 are arranged coaxially on the back side of the first picking roll 16 and are directly adjacent to each other. They are driven through corresponding gears by shaft 46.

The second picking roll 18, as shown in FIG. 1, is also divided into a first portion and a second portion that are driven at the same speed as the portions 36, 36′ of the picking section of the first picking roll 16. Shafts and gears that correspond to those in FIG. 4 are used for this purpose.

Since the third gear 68 has the largest number of teeth, the feed auger 34 rotates relatively slowly, whereas the second portion 36′ lying downstream of the feed auger 34 in the plant flow rotates more quickly, since the second gear 64 is smaller than the third gear 68. The first portion 36 lying downstream of the second portion 36′ of the picking section of the first picking roll 16 again rotates faster than the second portion 36′ because the second gear 64 is larger than the first gear 60. The corresponding speeds can be in a ratio of, say, 1:1.5:2.

The parts of the plants 32 being harvested cooperating with the elements of the first picking roll 16 are apparent in FIG. 4. The relatively slowly rotating feed auger 34 conveys the stem of the plant beneath the cobs rightward into the picking gap so that undesired cob losses by sudden acceleration processes need not be feared. The feed auger 34 conveys the plant 32 only axially rearward, not tangentially downward. The second portion 36′ of the picking section cooperates with the parts of the plant 32 that generally carry the cobs. Since it is also driven relatively slowly, the plant 32 is treated gently and cob losses are avoided. When the plant 32 switches from the feed auger 34 to the second portion 36′, the plant 32 experiences a deceleration, since it is no longer conveyed by the feed auger 34 (with reference to the view depicted in FIG. 4) rightward. Instead the plant stem is conveyed downward through the picking section 36, whereas rearward transport occurs through one of the fingers 26 over the length of the picking gap. Because of this deceleration, the plant 32 is sloped rightward, which means that any cobs falling off through finger 26 are fed through the channel formed by covers 42 to the trough 40 with the transverse feed auger 44. When the plant 32 reaches the first portion 36 in which it is pulled in more quickly than in the second portion 36′, the cobs are already separated so that no losses need be feared even during more rapid gathering.

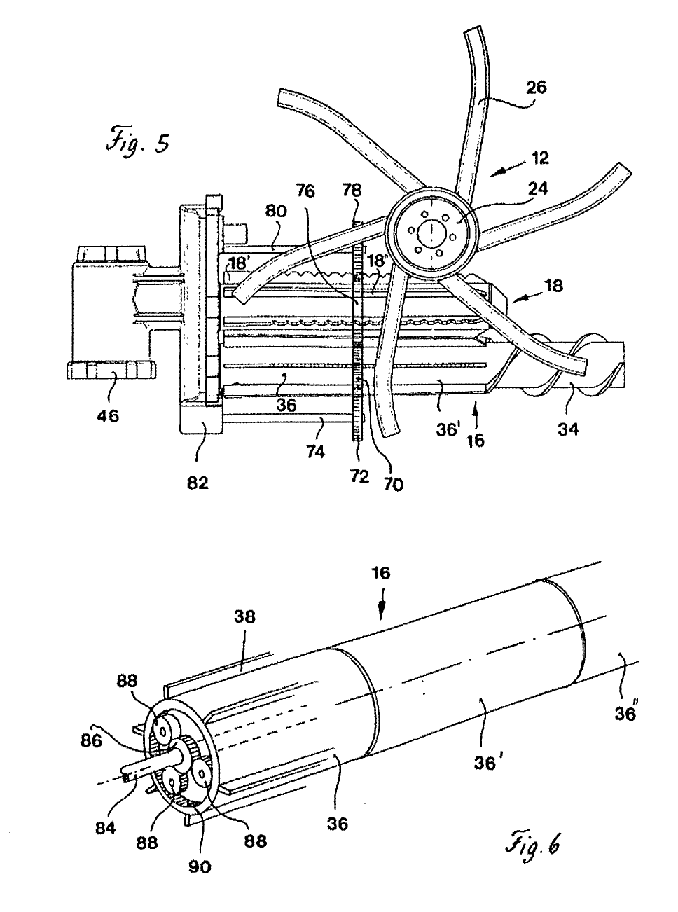

A top view of a gathering and picking device 10 with picking rolls 16 and 18 according to a second embodiment of the invention is illustrated in FIG. 5. The first picking roll 16 also has a picking section 36 that is divided into a first portion 36 and a second portion 36′. The second portion 36′ is rigidly connected to feed auger 34 and also drives the feed element 52. The second picking roll 18 is also divided into a first portion 18′ and a second portion 18″.

The drive of the first portion 36 of the picking region of the first picking roll 16 occurs from the back side in similar fashion to the first embodiment. The second portion 36′ is provided on its back end with external gearing 70 that meshes with a gear 72 driven by a shaft 74 running parallel to the axis of picking roll 16. The first portion 18′ of the second picking roll 18 is also driven from the back side conventionally. The second, front portion 18″ of the second picking roll 18 is equipped on its back end with external gearing 76 that meshes with gear 78 driven by shaft 80 that runs parallel to the axis of the second picking roll 18. The shafts 74 and 80 extend into a gear housing 82 that also accommodates the picking rolls 16 and 18. The second portions 36′ and 18″ generally rotate at a lower speed than the first portions 36 and 18′ of the picking sections of the picking rolls 16 and 18.

Finally, FIG. 6 shows a picking roll 16 according to a third embodiment of the invention. A central shaft 84 extends through and rotates a first portion 36 and a second portion 36′ of picking roll 16. The shaft 84 is connected to rotate in unison with a sun gear 86 that meshes with three planet gears 88 distributed around its periphery. The planet gears 88 are mounted to rotate in a fixed planet gear carrier (not shown). The planet gears 88 also mesh with an internal gearing 90 of the first portion 36′. Additional such planetary gears, each having different gear ratios, place the second and third portions 36′ and 36″ in rotation. The planet gear carriers are fixedly mounted by corresponding support elements that are not shown in the drawing for reasons of clarity. It would also be conceivable in this embodiment to drive the first portion 36 directly (without a planetary gear) as in the first embodiment, thus saving one planet gear. Instead of the third portion 36″ a feed auger 34 can also be included. The second picking roll 18 would then merely be designed from two portions having different speeds.

It would also be conceivable to drive a sun gear from the front side of the first portion 36 and the sun gear would drive the second portion 36′ via planet gear. The sun gear would sit on a hollow shaft, in whose interior a connection would extend between the planet gear carrier and a fixed element, for example, a gear housing. In this manner the third portion 36″ or the feed auger 34 are driven by the front of the second portion 36′.

Having described the illustrated embodiment, it will become apparent that various modifications can be made without departing from the scope of the invention as defined in the accompanying claims.

1. A picking roll that can be rotated comprises a picking section for tangential pulling in a plant, the picking section having a first portion that is driven at a first speed and a second portion that is driven at a second speed, the first and second speeds being different.

2. A picking roll as defined by claim 1 wherein the first portion is cylindrical having a first diameter and the second portion is cylindrical and has a second diameter.

3. A picking roll as defined by claim 2 wherein the first diameter is substantially the same as the second diameter.

4. A picking roll as defined by claim 3 wherein the first portion is arranged downstream from the second portion, the first speed being higher than the second speed.

5. A picking roll as defined by claim 5 wherein a third portion of the picking section is driven at a third speed that differs from the first and second speeds.

6. A picking roll as defined by claim 4 wherein the second portion is driven by a shaft that extends through the first portion.

7. A picking roll as defined by claim 4 wherein the second portion is driven by a hollow shaft having a shaft that extends through the hollow shaft to drive a feed auger mounted in front of the picking section, the feed auger being coaxial to the second portion.

8. A picking roll as defined by claim 5 wherein the second portion is driven by a hollow shaft having a shaft that extends through the hollow shaft to drive the third portion of the picking section mounted in front of the second portion, the third portion being coaxial to the second portion.

9. A picking roll as defined by claim 4 wherein the second portion is driven by planet gears located in the interior of picking roll.

10. A picking roll as defined by claim 5 wherein the third portion is driven by the planet gears located in the interior of picking roll.

11. A picking roll as defined by claim 4 wherein the second portion has external gearing that cooperates with a drive pinion.

12. picking roll as defined by claim 5 wherein the third portion has external gearing that cooperates with a drive pinion.

13. A picking roll as defined by claim 1 wherein the first portion is arranged downstream from the second portion, the first speed being higher than the second speed.

14. A picking roll as defined by claim 14 wherein a third portion of the picking section is driven at a third speed that differs from the first and second speeds.

15. A harvesting machine comprising:
a frame,
a picking roll being rotatively mounted to the frame, the picker roll having a picking section for tangential pulling in a plant, the picking section having a first portion that is rotatively driven at a first speed and a second portion that is rotatively driven at a second speed, the first and second speeds being different.

16. A harvesting machine as defined by claim 15 wherein the first portion is arranged downstream from the second portion, the first speed being higher than the second speed.

17. A harvesting machine as defined by claim 16 wherein a third portion of the picking section is driven at a third speed that differs from the first and second speeds.

18. A harvesting machine as defined by claim 16 further comprising a gathering element for directing a standing plant to the picking roll.

19. A harvesting machine as defined by claim 18 further comprising a second picking roll being rotatively mounted to the frame and arranged parallel to the picking roll.

20. A harvesting machine as defined by claim 19 wherein the second picking roll has a picking section for tangential pulling in a plant, the picking section of the second picking roll having a first portion that is rotatively driven at a first speed and a second portion that is rotatively driven at a second speed that is different from the first speed.
